(19) United States
(12) Patent Application Publication
(10) Pub. No.: US 2010/0111818 A1
(43) Pub. Date: May 6, 2010

(54) REMOVAL OF CONTAMINANTS FROM BY-PRODUCT HYDROCHLORIC ACID

(76) Inventor: Frederick J. Haydock, Murray, UT (US)

Correspondence Address: THORPE NORTH & WESTERN, LLP., P.O. Box 1219, SANDY, UT, 84091-1219, US

(21) Appl. No.: 12/608,588

(22) Filed: Oct. 29, 2009

Related U.S. Application Data
(60) Provisional application No. 61/109,414, filed on Oct. 29, 2008.

(51) Int. Cl. C01B 7/01; B01D 17/00

(52) U.S. Cl. 423/481; 210/729

(57) ABSTRACT

The present disclosure is drawn to a method for removing colloidal titanium dioxide and titanium oxychloride from by-product hydrochloric acid, typically without the use of metallic hydroxides and/or other neutralizing agents. Often, the decontaminated hydrochloric acid product is commercial grade and has concentrations greater than 85 wt % of the concentration of untreated by-product hydrochloric acid. The method includes adding phosphate ion source and quaternary amine or other precipitating agent to the by-product hydrochloric acid to cause the titanium dioxide and the titanium oxychloride to form a precipitate. In one embodiment, the method further includes heating at least one of the phosphate ion source, the quaternary amine or alternative precipitating agent, the by-product hydrochloric acid, or combination thereof. The precipitate can then be separated from the acid, thus producing a decontaminated hydrochloric acid product with reduced levels of titanium and other contaminants.

The present application claims the benefit of U.S. Provisional Patent Application No. 61/109,414, filed on Oct. 29, 2008, the entirety of which is incorporated herein by reference.

### BACKGROUND

Certain processes for producing titanium dioxide generally rely on the use of chlorine, hydrochloric acid or sulfuric acid. As such, a waste stream of by-product hydrochloric acid or by-product sulfuric acid is produced. A by-product hydrochloric acid contains a variety of contaminants including colloidal silica, colloidal titanium dioxide, titanium oxychloride, and lesser amounts of other trace and heavy metal impurities. Recently, there has been approximately 105,959,800 gallons (523,000 short tons) of by-product hydrochloric acid produced annually in the United States and Canada alone. Typically, this by-product hydrochloric acid is disposed of as waste due to the great amounts of contaminants preventing further use of the by-product hydrochloric acid.

An example process for manufacturing titanium dioxide consists of heating an ilmenite ore or a rutile titanium oxide containing sand ore, and coke to a controlled roasting temperature of approximately 1000° C. A stream or current of chlorine gas is passed into the heated carbon ore, at which point titanium tetrachloride, silicon tetrachloride, iron chloride, cadmium chloride and other trace inorganic chloride gases are formed. The lower volatile inorganic chloride gases with any of the other unreacted, beginning materials are removed by condensation. The titanium tetrachloride and a very small fraction of some of the lower volatile compounds are oxidized with oxygen at 1400° C. to 1600° C. to form SiO₂ and crystals of rutile TiO₂ (the desired titanium dioxide) product of a required size. The titanium dioxide crystals are removed in the vapor phase, and the remaining vapors are quenched with water. The quenching produces by-product hydrochloric acid that contains contaminants of titanium dioxide, titanium oxychloride, silica and small amounts of acid soluble chlorides, e.g. iron chloride.

These contaminants generally prohibit the re-use of the hydrochloric acid in other processes. For example, the concentration levels of contaminants such as silica and titanium dioxide in the hydrochloric acid stream render the acid unusable for most steel pickling processes and chemical manufacturing processes. Instead, the acid streams are disposed as waste, stored indefinitely, and/or possibly subjected to a variety of reclamation processes that can be time-intensive and costly. Often, the waste streams are neutralized, such as with caustic soda or hydrated lime, to form a brine solution for disposal.

### SUMMARY

It has been recognized that it would be desirable to provide methods and systems to effectively treat by-product hydrochloric acid waste streams, particularly those containing colloidal silica, titanium dioxide, and titanium oxychloride, to a purity that provides some use for the decontaminated hydrochloric acid product in chemical processes, such as steel pickling. As such, the disclosure herein outlines an economical and relatively fast method to produce an acceptable quality and quantity of decontaminated hydrochloric acid product from the by-product hydrochloric acid.

Rather than neutralizing and disposing of the by-product hydrochloric acid, the method herein uses a phosphate ion source and a quaternary amine to allow for separating colloidal titanium dioxide and titanium oxychloride from the by-product hydrochloric acid. Specifically, the method includes adding phosphate ion source and amine to the by-product hydrochloric acid and adding heat to at least one component of the mixture sufficient to cause the titanium dioxide and the titanium oxychloride to precipitate at an accelerated rate of precipitation. A decontaminated acid product can then be separated from the precipitate.

In another aspect, particularly useful where residual quaternary amine polymer is undesirable, a method for removing colloidal titanium dioxide and titanium oxychloride from by-product hydrochloric acid includes adding phosphate ion source and a precipitating agent to the by-product hydrochloric acid sufficient to cause the titanium dioxide and the colloidal titanium oxychloride to destablize and form a precipitate. The precipitating agent can be an amine or phosphate, such as hydroxylamine, diammonium phosphate, ammonium phosphate, halogenated primary amine (e.g., chlorinated), hydroxylammonium chloride, hydroxylammonium phosphate, or a combination thereof. A decontaminated and often commercial acid product can then be separated from the precipitate. Optionally, the method can include increasing the temperature of at least one of the phosphate ion source, the precipitating agent, the by-product hydrochloric acid, or any mixture thereof.

In another embodiment, a commercial grade hydrochloric acid, which has been decontaminated and recovered from by-product hydrochloric acid used to prepare titanium dioxide, can comprise decontaminated hydrochloric acid, and very low residual amounts of phosphate ion, titanium dioxide, titanium oxychloride, and silica. The hydrochloric acid can be substantially free of quaternary amine polymer.

This process can remove a substantial amount of contaminant titanium and even, in some embodiments, silica while maintaining the concentration integrity of the starting by-product hydrochloric acid. Decontaminated acid produced through this method can be used in later chemical processes such as in steel pickling and for the manufacture of aluminum chloride and other metallic chloride water treatment chemicals.

Additional features and advantages of the disclosure will be apparent from the detailed description that follows, which illustrates, by way of example, features of the invention.

### DETAILED DESCRIPTION

Reference will now be made to the exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. It is also to be understood that the terminology used herein is used for the purpose of describing particular embodiments only. The terms are not intended to be limiting unless specified as such.

It is noted that, as used in this specification and the appended claims, the singular forms “a,” “an,” and “the” include plural referents unless the content clearly dictates otherwise.

The term “contaminant” refers to undesirable chemical components in an acid that are typically introduced by the use of that acid in another chemical process. For example, the use of chlorine or hydrochloric acid in the preparation of titanium dioxide generates several contaminants. Contaminants specifically addressed by the method disclosed herein include colloidal titanium dioxide, titanium oxychloride, colloidal silica, silicon oxychloride, as well as other metallic and non-metallic contaminants containing oxides and oychloride ions. Similarly, the term “decontaminated” in reference to an acid, indicates an acid wherein at least a portion of at least one contaminant has been removed. Thus, decontamination does not infer that all contaminates have been removed, but that the contaminants are removed to an extent that the recovered acid can be used in other commercial methods.

The term “phosphate ion source” can include any source of phosphate ions, including, but not limited to, phosphoric acid, sodium phosphate, calcium phosphate, phosphonates, etc.

As used herein, “phosphoric acid” refers to a chemical including the phosphoric acid, usually substantially of the type orthophosphoric acid form. Orthophosphoric acid has the chemical formula H₃PO₄.

The term “polyamine” refers to compounds having at least one amine group. Thus, a polymeric amine would be considered a polyamine, as well as small molecules that have multiple amines.

The term “wt % by-product hydrochloric acid” indicates that a weight percentage of an additive is based on the total amount of the by-product hydrochloric acid being treated.

The term “alternative precipitating agent” or “precipitating agent” refers to agents used when a quaternary amine is not used, e.g., hydroxylamine, diammonium phosphate, ammonium phosphate, halogenated primary amine, hydroxylammonium chloride, hydroxylammonium phosphate, or combinations thereof. In one embodiment, the hydroxylamine can optionally be or include hydroxylamine hydrochloride, or the halogenated primary amine can be chlorinated primary amine.

The term “substantially free” refers to the total absence of or near total absence of a specific compound or composition. For example, when a composition is said to be substantially free of alkylated amines, there are either no alkylated amines in the composition or only residual amounts of alkylated amines in the composition. Likewise, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a volume concentration range of about 1 wt % to about 20 wt % should be interpreted to include not only the explicitly recited limits of 1 wt % and about 20 wt %, but also to include individual weights such as 2 wt %, 11 wt %, 14 wt %, and sub-ranges such as 10 wt % to 20 wt %, 5 wt % to 15 wt %, etc.

It is noted that in many embodiments herein, the phosphate ion source and the quaternary amine are described as being added to the by-product hydrochloric acid to cause the colloidal titanium dioxide and the titanium oxychloride to form a precipitate. That being said, other phosphate or amine precipitating agents can be used in addition to or in stead of the quaternary amine with acceptable results. Thus, when describing quaternary amine as an additive, it is understood expressly that alternative precipitating agents as defined herein can likewise or alternatively be used. Likewise, in embodiments where an alternative precipitating agent is described as being used, it is understood that that chemical can be replaced or used in conjunction with a quaternary amine.

In accordance with this, it has been recognized by industry for many years that it would be beneficial to develop a way to remove contaminants, such as colloidal silica, colloidal titanium dioxide and titanium oxychloride from by-product hydrochloric acid. By removing the contaminants from the by-product hydrochloric acid, a product acid can be formed that can have utility in chemical processing, such as in steel pickling or the manufacture of aluminum chloride and other chloride water treatment chemicals.

As such, a method is presented for removing colloidal titanium dioxide and titanium oxychloride from by-product hydrochloric acid. The method includes adding phosphate ion source and quaternary amine to the by-product hydrochloric acid to cause the colloidal titanium dioxide and the titanium oxychloride to form a precipitate. The method can further include separating the precipitate from the liquid, thus producing a decontaminated acid product of hydrochloric acid. In a non-limiting example, such by-product hydrochloric acid can be by-products of titanium dioxide chemical processing.

In another aspect, particularly useful where residual quaternary amine polymer is undesirable, a method for removing colloidal titanium dioxide and titanium oxychloride from by-product hydrochloric acid includes adding phosphate ion source and a precipitating agent to the by-product hydrochloric acid sufficient to cause the titanium dioxide and the colloidal titanium oxychloride to destablize and form a precipitate. The precipitating agent can be an amine or phosphate, such as hydroxylamine, diammonium phosphate, ammonium phosphate, halogenated primary amine (e.g., chlorinated), hydroxylammonium chloride, hydroxylammonium phosphate, or a combination thereof. A decontaminated and often commercial acid product can then be separated from the precipitate. Optionally, the method can include increasing the temperature of at least one of the phosphate ion source, the precipitating agent, the by-product hydrochloric acid, or any mixture thereof.

In another embodiment, a commercial grade hydrochloric acid, which has been decontaminated and recovered from by-product hydrochloric acid used to prepare titanium dioxide, can comprise decontaminated hydrochloric acid and residual amounts of phosphate ion, amine, titanium dioxide, titanium oxychloride, and silica. The hydrochloric acid can be substantially free of quaternary amine polymer.

This process can remove a substantial amount of contaminant titanium and even, in some embodiments, silica while maintaining the concentration integrity of the starting by-product hydrochloric acid. Decontaminated acid produced through this method can be used in later chemical processes such as in steel pickling and for the manufacture of aluminum chloride and other metallic chloride water treatment chemicals.

It is noted that in some embodiments, it may be useful to manipulate the concentration of the phosphate ion source when using some of the alternative precipitating agents described herein so as to maintain the phosphate ion concentration and strength in destabilizing the colloidal titanium oxide suspensions and metallic oxychlorides. Such modifications would be apparent to one skilled in the art after considering the present disclosure.

The chemistry to remove the titanium dioxide and the titanium oxychloride contaminants from the by-product hydrochloric acid can be relatively complex, as the titanium dioxide exists in a colloidal suspension. With colloidal suspensions, a factor in forming precipitates is related to the dimension or size of the colloids. The size of the colloidal titanium dioxide particles, as calculated by centrifuging and filtering samples, is smaller than about 0.2 μm. Thus, the surface area to volume ratio is very high. As such, the colloidal titanium dioxide particles do not readily settle out of solution under the forces of gravity, and remain as a colloidal suspension.

Common technologies pertaining to the production of titanium dioxide and the improvement for recovering titanium dioxide particles in manufacturing processes teach of the use of neutralizing the recovered solutions with hydroxides and other chemicals to a pH of 3-5. However, none of the current technologies teach of forming a precipitate under highly acidic conditions and recovering the acid from the process and the titanium in the form of a precipitate that, once separated from the acid, can be recovered and treated for recovering the titanium. Furthermore, these methods do not provide an acceptable method of recovering the acid economically as a commercial acid for use in manufacturing or other processes.

Another common contaminant in by-product hydrochloric acid is silica. Silica can exist in a colloidal state and, if allowed enough time, will settle out of solution and agglomerate at the bottom of a storage tank in a hard block, due at least in part to silica's affinity for hydroxyl ions. Colloidal titanium dioxide does not share the same affinity, and does not have a tendency to appreciably settle out of by-product hydrochloric acid, even if left for 12 months in storage. In tests related to the concentration of titanium in by-product hydrochloric acid left for long periods of storage, the overall concentration change of the titanium was less than 2 wt %, thus indicating that the bulk of titanium remained in a colloidal suspension or as a soluble form of titanium oxychloride, with a minor amount attaching to the container walls. Where titanium oxychloride is soluble in the by-product hydrochloric acid, the presence of titanium oxychloride also hinders the removal of colloidal titanium dioxide.

As by-product hydrochloric acid contains both colloidal titanium dioxide and titanium oxychloride contaminants, it is useful to utilize a method that can successfully remove both contaminants from the by-product hydrochloric acid. To remove the contaminants, a phosphate ion source and a quaternary amine or other alternative precipitating agent are added to destabilize the titanium oxychloride, thereby forming a titanium phosphate seed to initiate gelation of the colloidal titanium dioxide.

The phosphate ion source, such as phosphoric acid, sodium phosphate, calcium phosphate, phosphonates, and mixtures thereof, can react with titanium oxychloride as illustrated in the following Formulas. In one embodiment, the phosphate ion source can include a phosphoric acid. For example, the addition of phosphoric acid to titanium oxychloride is shown as Formula 1, and the addition of phosphoric acid to titanium dioxide is shown as Formula 2.

3TiOCl₂+4H₃PO₄→Ti₃(PO₄)₄+6HCl+3H₂O Formula 1

TiO₂+H₃PO₄→H₃PO₄.TiO₂ (gel) Formula 2

The amount of phosphoric acid added to the by-product hydrochloric acid should be sufficient to stimulate and accelerate, along with the quaternary amine (or other alternative precipitating agent), the formation of precipitates of the titanium oxychloride and the colloidal titanium dioxide. In one embodiment, from about 0.20 wt % to about 3.5 wt % by-product hydrochloric acid can be present. For example, 12 g/gallon by-product hydrochloric acid to about 125 g/gallon by-product hydrochloric acid of phosphoric acid can be added. Such calculations are based on 1 gallon of by-product hydrochloric acid having a weight of approximately 9.1 lbs to 9.4 lbs per gallon. Such addition can vary depending on the amount of contaminant, the type of by-product hydrochloric acid, the desired recovery rate of decontaminated acid, the desired precipitation formation time before separation, etc. Additionally, the amount of phosphoric acid added can depend on the amount and type of quaternary amine added, as well as the amount and type of any other phosphate ion sources added. For example, in one aspect, phosphoric acid and quaternary amine can be added, without other phosphate ion sources. In such embodiment, and as a non-limiting example, the amount of phosphoric acid can range from about 25 g/gallon to about 125 g/gallon by-product hydrochloric acid. In a more specific embodiment, from about 50 g/gallon to about 75 g/gallon by-product hydrochloric acid of phosphoric acid can be added. In an alternate embodiment, phosphoric acid can be one of a plurality of phosphate ion sources added. For example, phosphoric acid and metallic phosphate salt can be added to cause the formation of a precipitate, along with quaternary amine. In such case, generally less phosphoric acid is used. In one aspect, from about 12 g/gallon to about 65 g/gallon by-product hydrochloric acid of phosphoric acid can be added. In a more specific aspect, from about 20 g/gallon to about 40 g/gallon by-product hydrochloric acid of phosphoric acid can be added.

In another embodiment, the phosphate ion source can comprise or consist essentially of a metallic phosphate salt. Such metallic phosphate salt can include one or a plurality of distinct metallic phosphate salts. Formulas 3 through 6 illustrate the addition of two metallic phosphate salts, sodium phosphate and calcium phosphate, to titanium oxychloride and to colloidal titanium dioxide. Specifically, Formula 3 shows the reaction between titanium oxychloride and sodium phosphate, Formula 4 shows the reaction between titanium oxychloride and calcium phosphate, Formula 5 illustrates the reaction between colloidal titanium dioxide and sodium phosphate, and finally Formula 6 shows the reaction between colloidal titanium dioxide and calcium phosphate.

3TiOCl₂+2 Na₃PO₄+2H₃PO₄→Ti₃(PO₄)₄+6 NaCl+3H₂O Formula 3

3TiOCl₂+Ca₃(PO₄)₂+2H₃PO₄→Ti₃(PO₄)₄+3 CaCl₂+3H₂O Formula 4

TiO₂+Na₃PO₄→Na₃PO₄TiO₂ (gel) Formula 5

TiO₂+Ca₃(PO₄)₂→Ca₃(PO₄)₂TiO₂ (gel) Formula 6

The gel that is formed in Formulas 2 and 5-6 is typically a fluffy, voluminous precipitate composed of particles of titanium dioxide with surface area still slightly larger than volume. These particles can attach to receptor molecules and form gel that is stratified in bulky, suspended layers within the treated by-product hydrochloric acid. Eventually in some embodiments, the bulk of the precipitate can fall out of solution and agglomerate at the bottom of the settling container.

The category of metallic phosphate salt is not intended to be limited to sodium phosphates, such as trisodium phosphate, and calcium phosphates, such as tricalcium phosphate. Rather, such compounds were selected as illustrative of the reactions between metallic phosphate salts and colloidal titanium dioxide and titanium oxychloride. Metallic phosphate salts, therefore, can include any alkali metal, alkaline earth metal, and transition metal phosphate compounds.

As with the phosphoric acid, the amount of metallic phosphate salt added to the by-product hydrochloric acid should be sufficient to stimulate and accelerate, along with the quaternary amine, the formation of precipitates of the titanium oxychloride and the colloidal titanium dioxide. In one embodiment, from about 0.8 wt % to about 10.0 wt % by-product hydrochloric acid of metallic phosphate salt can be added. For example, 45 g/gallon to about 400 g/gallon by-product hydrochloric acid of metallic phosphate salt can be added. Such addition can vary depending on the type of metallic phosphate salt and the respective molecular weight used, the amount of contaminant, the type of by-product hydrochloric acid, the desired recovery rate of decontaminated acid, the desired precipitation formation time before separation, etc. Again as with the phosphoric acid, the amount of metallic phosphate salt added can depend on the amount and type of quaternary amine added, as well as the amount and type of any other phosphate ion sources added, including the variety of metallic phosphate salts used. In one embodiment, metallic phosphate salt and quaternary amine can be added, without other phosphate ion sources. In such embodiment, the amount of metallic phosphate salt can range from about 90 g/gallon to about 400 g/gallon by-product hydrochloric acid. In a more specific embodiment, from about 150 g/gallon to about 250 g/gallon by-product hydrochloric acid of metallic phosphate salt can be added.

In an alternate embodiment, metallic phosphate salt can be one of a plurality of phosphate ion sources added. For example, phosphoric acid and metallic phosphate salt can be added to cause the formation of a precipitate, along with a quaternary amine. In such case, generally less metallic phosphate salt is used, as it is not the sole source of phosphate ions. In one aspect, from about 45 g/gallon to about 200 g/gallon by-product hydrochloric acid of metallic phosphate salt can be added. In a more specific aspect, from about 75 g/gallon to about 125 g/gallon by-product hydrochloric acid of metallic phosphate salt can be added.

As briefly discussed, the phosphate ion source can comprise a single distinct chemical or can be a plurality of phosphate ion sources. In one embodiment, phosphate ion sources can comprise or consist essentially of any of phosphoric acids, metallic phosphate salts, and phosphonates. In one aspect, the phosphate ion source can include at least two different phosphate ion sources. For example, the phosphate ion source can include phosphoric acid and metallic phosphate salt. Further, the metallic phosphate salt can include a plurality of distinct metallic phosphate salts. A non-limiting example of this case would be the use of calcium phosphate and sodium phosphate together. In a specific embodiment, the phosphate ion source can be substantially free of alkylated phosphates. Additionally, the phosphate ion source can be low-carbon phosphates, i.e. C1-C6 phosphates.

Adding a quaternary amine to the by-product hydrochloric acid along with the phosphate ion source can increase the rate of precipitate formation. In one embodiment, the quaternary amine can be a polymeric quaternary amine. Such quaternary amines can be charged. For example, the polymeric quaternary amine can be cationic or anionic. Non-limiting examples of quaternary polyamines that can be used include polymeric quaternary amines, such as, but not limited to, liquid cationic polymeric coagulants by Cytec, such as Cytec C-572, C-573, C-577, and C-581. General Electric also produces polymeric quaternary amines, such as PC 1195, that can be used in the present application In addition, Ciba Geigy's A-50 and Calloway's low and medium chain amines can be used in accordance with embodiments of the present disclosure. In a specific embodiment, the quaternary amine or other amine can be substantially free of alkylated amines.

The amount of quaternary amine used is typically less than the total amount of phosphate ion source. In one embodiment, about 5.0 g/gallon to about 50.0 g/gallon by-product hydrochloric acid of quaternary amine can be used. In a more specific embodiment, from about 0.10 wt % to about 1.25 wt % by-product hydrochloric acid of quaternary amine can be used. For example, about 10.0 g/gallon to about 20.0 g/gallon by-product hydrochloric acid of quaternary amine can be used. Still in a further embodiment, from about 12.0 g/gallon to about 15.0 g/gallon by-product hydrochloric acid of quaternary amine can be used. While the by-product hydrochloric acid can include a variety of contaminants in varying concentrations, and can further have varying acid concentrations as a result of the process that produces the by-product hydrochloric acid, in one aspect, the acid concentration can range from about 18 wt % to about 30 wt %. Under many processing conditions, the by-product hydrochloric acid can weigh from about 9.1 lbs to about 9.4 lbs per gallon. In one aspect of the present application, the respective amounts of additives such as phosphate ion source and quaternary amine can be adjusted according to the noted by-product hydrochloric acid weight in relation to the treated by-product hydrochloric acid.

In some instances, quaternary or primary amines can interfere in manufacturing processes that may use the treated by-product hydrochloric acid. For example, a hydrochloric acid stream including quaternary amines is undesirable for use in making aluminum chlorides, polyaluminum chlorides, and aluminum chloro hydrate. The residual quaternary amine polymer, for example, in the by-product hydrochloric acid can slow down the reaction rate. The reaction rate for the formation of aluminum chloro hydrate, for example, can be slowed by many hours by the presence of quaternary amine polymer in the by-product hydrochloric acid. Additionally, the manufacturing of commercial pigments would likely require re-formulation and re-design of current processes to account for and mitigate unwanted effects of excessive polymer content in the treated by-product hydrochloric acid. Alternatively, the commercial pigments would require recertification of pigment formulations, at significant expense.

To reduce and/or eliminate these undesirable attributes of the treated by-product hydrochloric acid, the quaternary amine can be replaced with an alternative precipitating agent. The precipitating agent can be selected from the group of hydroxylamine, diammonium phosphate, ammonium phosphate, and combinations thereof. The hydroxylamine can optionally be or include hydroxylamine hydrochloride. By utilizing a precipitating agent in place of the quaternary amine, the effects of accelerated precipitation in combination with phosphate ion source are maintained, while producing a treated by-product hydrochloric acid substantially free of quaternary amine.

It should be noted, however, that in one aspect, any combination of phosphate ion source, quaternary amine and precipitating agent can be utilized to induce precipitation and thus separation of the titanium from by-product hydrochloric acid. For example, each of the phosphate ion source, quaternary amine and precipitating agent can be utilized simultaneously, or step-wise, in the same treatment. Alternatively, the quaternary amine and the precipitating agent can be utilized together.

Generally, the replacement of the quaternary amine by one or more precipitating agent is a direct replacement in both use within the process (e.g. addition time, etc.) and amount. As such, the discussion of amounts and use of the quaternary amine throughout the present specification is understood to be directed to replacement with one or more precipitating agents. In one aspect, the precipitating agent comprises or consists essentially of hydroxylamine. The hydroxylamine can include hydroxylamine, hydroxylamine hydrochloride (also known as oxammonium hydrochloride), or mixtures thereof. The hydroxylamine is generally used in amounts consistent with those of the quaternary amine. In one embodiment, hydroxylamine is present in an amount from about 0.65 wt % to about 1.25 wt % by-product hydrochloric acid.

In another embodiment, the alternative precipitating agent can comprise or consist essentially of diammonium phosphate. Alternatively, the precipitating agent can comprise or consist essentially of ammonium phosphate. In each case, the amounts used can be the same as those taught for use of the quaternary amine. In a specific embodiment, the amount can be from about 0.45 wt % to about 1.5 wt % by-product hydrochloric acid.

When utilizing an alternative precipitating agent in place of the quaternary amine, the phosphate ion source remains the same in composition, amount, and use.

By-product hydrochloric acid streams of the type described herein often contain silicon-based contaminant, such as silica, often in a colloidal form, and silicon oxychloride. The presence of such contaminants can reduce the usefulness or effectiveness of decontaminated acid produced through the methods disclosed herein. Fortunately, silica and silicon oxychloride can be removed in a manner presented herein for the removal of titanium dioxide and titanium oxychloride. As such, silica and silicon oxychloride can be removed from by-product hydrochloric acid through the presently disclosed methods, i.e. adding phosphate ion source and quaternary amine to the by-product hydrochloric acid; or adding phosphate ion source and an alternative precipitating agent; and, in both cases, separating the precipitate from the decontaminated acid product. Further, the silica precipitate is more manageable than the precipitate of other systems. As mentioned, if the silica is not removed, it forms a hard block of material at the bottom of a settling tank. This hard block would otherwise require intense mechanical and/or extensive chemical treatment to remove the material from the tank. Such treatment is time-intensive, and can, in some instances, be harmful to the process equipment. By precipitating silica and silicon oxychloride from the hydrochloric acid with the addition of a phosphate ion source and either a quaternary amine or alternative precipitating agent, the precipitated silicon-based contaminants produce a precipitate that is easily handled and does not form a hard block of material.

The addition of the phosphate ion source and either a quaternary amine or alternative precipitating agent can be in any order that effectuates the formation of a precipitate of titanium contaminants in the by-product hydrochloric acid. As such, the phosphate ion source can be added before either a quaternary amine or alternative precipitating agent. Alternatively, either a quaternary amine or alternative precipitating agent can be added before the phosphate ion source. There can be a time-lag of minutes to hours between additions, although it is currently preferred to add the phosphate ion source and either the quaternary amine or the alternative precipitating agent with relatively little time lag. Additionally, the phosphate ion source and either a quaternary amine or alternative precipitating agent can be added to the by-product hydrochloric acid simultaneously. Such addition can include adding the phosphate ion source and either a quaternary amine or alternative precipitating agent at the same time to the by-product hydrochloric acid, or can include pre-mixing the phosphate ion source and either a quaternary amine or alternative precipitating agent together and then adding the mixture to the by-product hydrochloric acid.

In one aspect, the phosphate ion source and either a quaternary amine or alternative precipitating agent can be mixed in with the by-product hydrochloric acid. Such mixing can be by low-shear to no-shear mixing. The amount of time is dependent on the particular by-product hydrochloric acid, phosphate ion source, either the quaternary amine or alternative precipitating agent, and amounts of each, as well as desired decontaminated acid characteristics. As a non-limiting example, the phosphate ion source and either the quaternary amine or alternative precipitating agent can be mixed with the by-product hydrochloric acid for a time from about 30 minutes to about 5 hours. In a further example, the mixing time can be from about 30 minutes to about 3 hours.

The phosphate ion source and either the quaternary amine or the alternative precipitating agent can benefit from a period of time to form a precipitate of the colloidal titanium dioxide and titanium oxychloride. Such settling times can range from hours to days. However, with the action of both the phosphate ion source and either the quaternary amine or the alternative precipitating agent, settling times are accelerated compared to other precipitation processes. In one embodiment, the step of separating the decontaminated acid product from the precipitate can occur in less than about 50 hours after adding phosphate ion source and either the quaternary amine or the alternative precipitating agent to the by-product hydrochloric acid. In another embodiment, the step of separating can occur in less than about 30 hours after adding phosphate ion source and either the quaternary amine or the alternative precipitating agent to the by-product hydrochloric acid. Under some circumstances, the step of separating can occur less than about 20 hours after adding phosphate ion source and either the quaternary amine or the alternative precipitating agent to the by-product hydrochloric acid.

Typically, lower amounts of the metallic phosphate salt and phosphoric acid can increase the time to achieve the same volume of acid recovery by several days of settling time. The higher amounts of phosphoric acid and metallic phosphate salt do not, however, typically improve the volume of acid in a shorter period of time and, in fact actually slow the process down, even with the addition of either the quaternary amine or the alternative precipitating agent. Thus, an optimized level of phosphate ion source can be experimentally obtained for each by-product hydrochloric acid. The combination of phosphate ion source and either the quaternary amine or the alternative precipitating agent functions to initiate and accelerate the precipitation of contaminants from by-product hydrochloric acid while maintaining hydrochloric acid concentrations for commercial applications at or near original by-product concentrations.

The step of separating the decontaminated acid product from the precipitate can be completed by any presently known method of separation, including decanting, centrifuging, filtering, sedimentation, or combinations thereof. In a specific embodiment, the step of separating can include filtering.

The methods described herein can optionally include use of heat. Such use is not required, however, and all portions of the method, either separately, or as a whole, can be performed at or below room temperature. Therefore, in one embodiment, the method, including adding phosphate ion source and either the quaternary amine or the alternative precipitating agent to a by-product hydrochloric acid and separating an acid product, can be performed at or below room temperature. In another embodiment, the step of adding phosphate ion source and either the quaternary amine or the alternative precipitating agent to a by-product hydrochloric acid can be performed at room temperature. In still another embodiment, the separate optional steps of mixing and allowing settling time can be performed at room temperature individually or collectively. In another embodiment, the method can be performed at temperatures less than about 20 degrees below the boiling point of the components, i.e. acid, phosphate ion source, and either the quaternary amine or the alternative precipitating agent. Generally, heating the by-product hydrochloric acid being treated can improve the precipitation rate. In a batch process, for example, the precipitation time required can be reduced by several hours or more, utilizing from about 2,000 gallons to about 100,000 gallons of by-product hydrochloric acid. In a non-limiting example, in batch processing, an ambient processing precipitation settling time can range from about 12 to about 20 hours, but the time can be reduced by as much as 50% if the settling temperature is increased by about 10° F. to about 60° F. With this temperature range as a guide, it is generally contemplated that any similar increase in temperature outside of this range can increase the precipitation rate. Thus, this range is not provided to be limiting, as long as the increase in temperate provides reduced processing time.

Various heating methods can be utilized to elevate the temperature of the processing by-product hydrochloric acid. In one embodiment, any of the components added to the by-product hydrochloric acid can be individually heated prior to addition. For example, the phosphate ion source can be heated prior to addition into the by-product hydrochloric acid. Similarly, the by-product hydrochloric acid can be heated prior to adding any processing components. Alternatively, the by-product hydrochloric acid can be heated following addition of one or more processing additives. Such heating can be accomplished by any method of heating known in the art. Other non-limiting examples of heating can include heat from ambient temperatures, such as, for example, outdoor processing in warmer climates and/or during warmer seasons, heating by solar radiation, or other radiation, heat transfer mechanisms such as jacketed reactors, coiled heat transfer process design, etc.

The heating can result in elevated temperature of the mixture, which can optionally be maintained for any duration of the settling and precipitation time. In one aspect, the mixture can be heated to a temperature greater than about 10° F. about ambient temperature. In a further aspect, the mixture can be heated to greater than about 30° F. above room temperature. In one embodiment, the mixture can be heated to greater than about 75° F. In a further embodiment, the mixture can be heated to greater than about 100° F. The heating can last, as noted, for any duration. In one example, the heating can be pre-heating of at least one of the components or the by-product hydrochloric acid. In another example, the heating can be of the mixture following mixing. In another aspect, the heating and elevated temperature can be for the majority or even the entire duration of the mixing and precipitation time.

Including a heating step can reduce the necessary time for separating the decontaminated acid from the precipitate. In one aspect, the separation can occur in less than about 80% of the time that would be required for a quantitatively identical separation process according to an identical method without the inclusion of a heating step. Similarly, the separation can occur in less than about 70% of the time compared when added heat is not used.

The removal of colloidal titanium dioxide and titanium oxychloride can be performed in batch, semi-batch, or continuous process conditions. Currently preferred embodiments utilize a batch process, and as such, much discussion is geared towards batch-type processing, however, it should be noted that various process conditions and equipment can be utilized to complete the methods described herein under a variety of processing conditions, and should not be limited to batch conditions.

Therefore, according to one embodiment of the current presented method, a by-product hydrochloric acid containing contaminants of the form of colloidal titanium dioxide, titanium oxychloride, optionally colloidal silica, silicon oxychloride, and metallic chlorides or other contaminants, can be circulated in a reaction vessel and/or settling tank. Phosphate ion source and either the quaternary amine or the alternative precipitating agent can be added to the by-product hydrochloric acid to destabilize the colloidal suspensions by gelation/agglomeration. The phosphate ion source and either the quaternary amine or the alternative precipitating agent can be blended and mixed in the reaction vessel tank for about 30 minutes to about 3 hours by slow, non-shearing mechanical agitation or circulation using diaphragm pumps. Colloidal titanium dioxide, titanium oxychloride, and optionally colloidal silica and silicon oxychloride can form a destabilizing gel that acts as a charged receptor molecule to attach sufficient particles to begin precipitation. After the agitation is terminated, the mixture can be allowed to sit in the reaction vessel for about 12 to about 16 hours where the precipitate can settle to the bottom of the vessel. Alternatively, the mixture can be pumped to another vessel, separate from the mixing vessel, for settling. The settling vessel can have, e.g., a coned, dished, or flat bottom. The decontaminated hydrochloric acid can remain in the upper portion of the vessel and can be pumped to a different storage tank. Additionally, the decontaminated acid can be pumped through a filter, such as a micron bag filter of at least about 5 microns to remove any suspended precipitate particles. The remaining precipitate can be removed from the vessel and properly disposed. Such disposal may include filter-pressing the precipitate and neutralizing it with a caustic solution, followed by disposal in landfill.

Use of the methods described herein can provide excellent results judged as effectively removing contaminants from by-product hydrochloric acid, producing a quality of decontaminated acid that can be used in other chemical processes, and at a relatively high recovery rate. In one embodiment, the titanium concentration in the by-product hydrochloric acid can be reduced by greater than about 95 wt % in the resulting decontaminated acid product. In a further embodiment, the titanium concentration can be reduced by greater than about 98 wt %. And in still a further embodiment, the titanium concentration can be reduced by greater than about 99 wt %. Such titanium concentration reductions can result in a decontaminated acid product having a titanium concentration of less than 50 ppm by weight, less than 40 ppm by weight, or even less than 25 ppm by weight while maintaining acid concentrations at or near the concentrations of the untreated by-product hydrochloric acid.

Likewise, in by-product hydrochloric acid having silica and/or silicon oxychloride, the silicon concentration can be reduced by greater than about 90 wt % in the product acid. In a further embodiment, the silicon concentration can be reduced by greater than about 95 wt %. Silicon levels in the decontaminated acid product can be less than about 20 ppm by weight. In further embodiments, the silicon concentration can be less than about 10 ppm by weight, or even less than about 5 ppm by weight. Such reduced concentrations of titanium and silicon are due, at least in part, to the time allotted to form the precipitate and the amount of settling time. As such, greater amounts of time can lead to further reduced contaminant concentrations. The above concentrations for titanium and silicon are provided with an anticipated separation step occurring less than about 30 hours after adding the phosphate ion source and either the quaternary amine or the alternative precipitating agent to the by-product hydrochloric acid. With the application of heat to the process, the separation step can occur at a faster rate. In one aspect, the anticipated separation step can occur less than about 16 hours and less than about 24 hours after adding the phosphate ion source and either the quaternary amine or the alternative precipitating agent.

With such contaminant removal, the decontaminated acid product can be commercial grade. In one embodiment, the decontaminated acid product recovery rate can be greater than about 45 wt % as based on the amount of decontaminated acid product compared to the amount of by-product hydrochloric acid. In a further embodiment, the recovery rate can be greater than about 55 wt %.

An added benefit to the decontamination of by-product hydrochloric acid can be color improvement. The color of the by-product hydrochloric acid can depend upon the number and concentration of the impurities in it. For example, an amber or greenish-yellow hue to the by-product hydrochloric acid normally indicates the presence of copper and iron, either as copper chloride, iron chloride, or as a ferro-titanium complex, which titanium complex yields a yellow-orange color in the presence of hydrogen peroxide. By-product hydrochloric acid of these hues, once processed according to the present methods, can have reduced color. Furthermore, if the alternative precipitating agent is used in place of the quaternary amine, the resulting treated by-product hydrochloric acid can be substantially free of quaternary amine.

### EXAMPLES

The following examples illustrate the embodiments of the disclosure that are presently best known. However, it is to be understood that the following are only exemplary or illustrative of the application of the principles of the present disclosure. Numerous modifications and alternative compositions, methods, and systems may be devised by those skilled in the art without departing from the spirit and scope of the present disclosure. The appended claims are intended to cover such modifications and arrangements. Thus, while the present invention has been described above with particularity, the following examples provide further detail in connection with what are presently deemed to be the most practical and preferred embodiments of the disclosure. It should be further noted that the concentration and type of contaminants is not limited to the examples provided.

### Example 1

### Hydrochloric Acid by-Product with Phosphoric Acid and Polymeric Quaternary Amine

To one gallon of by-product HCl, weighing 9.18 lbs-9.4 lbs and containing 19 wt % HCl, 2600 ppm by weight of titanium as titanium dioxide and 287 ppm by weight of silicon as silica, 63.55 grams of 85 wt % phosphoric acid and 13.0 grams of GE PC 1195 (a polymeric quaternary amine) is added. The mixture is heated to 20° F. above ambient and mixed for 1 hour under non-shearing conditions and allowed to settle. The elevated temperature is maintained during settling. The total mixing and settling time is approximately 15-20 hours. After settling, the decontaminated acid product is removed by decanting the supernatant liquid and filtering the precipitate and acid retained in the precipitate through a 2 micron bag filter. The resulting separation produces 0.5555 gallons of decontaminated acid product of 18.6 wt % HCl in the decanted phase, containing less than 50 ppm by weight of titanium as titanium dioxide and 10 ppm by weight of silicon, calculated as silicon dioxide.

### Example 2

### Control Example with No Heating

Comparatively, the same procedure of Example 1 is followed without the elevated temperature for mixing and settling. The procedure is followed all at ambient temperature. The total mixing and settling time to achieve the same result is 25 hours.

### Example 3

### Control Example with Only Phosphoric Acid and No Heating

To one gallon of by-product HCl weighing 9.18 lbs-9.4 lbs and containing 19 wt % HCl, 2600 ppm by weight of titanium as titanium dioxide and 287 ppm by weight of silicon as silica, 63.55 grams of 85 wt % phosphoric acid is added. The mixture is mixed for 1 hour under non-shearing conditions and allowed to settle. The total mixing and settling time is approximately 25 hours. After settling, the decontaminated acid product is removed by decanting the supernatant liquid and filtering the precipitate and acid retained in the precipitate through a 2 micron bag filter. The resulting separation produces 0.5278 gallons of 18.6 wt % HCl decontaminated acid product in the decanted phase, containing less than 50 ppm by weight of titanium as titanium dioxide and 10 ppm by weight of silicon, calculated as silicon dioxide. The analytical results for determining the titanium and silicon concentrations are performed on a Leeman ICP. As can be seen, the use of phosphoric acid and a polymeric quaternary amine as in Example 1, produces a higher yield of decontaminated acid in the same time.

### Example 4

### Hydrochloric Acid by-Product with Trisodium Phosphate and Polymeric Quaternary Amine

To one gallon of by-product HCl weighing 9.18 lbs-9.4 lbs and containing 19 wt % HCl, 2600 ppm by weight of titanium and 287 ppm by weight of silica, 189.6 grams of trisodium phosphate decahydrate, containing an equivalent of 52.34 grams of phosphate ion, and 13.0 grams of GE PC 1195 (a polymeric quaternary amine) is added. The mixture is heated to 30° F. above ambient temperature and mixed for 1 hour under non-shearing conditions and allowed to settle at the elevated temperature. The total mixing and settling time is approximately 15-18 hours. After settling, the decontaminated acid product is removed by decanting the supernatant liquid acid and filtering the precipitate and acid retained in the precipitate through a 2 micron bag filter. The resulting separation produces 0.6389 gallons of 18.5 wt % HCl decontaminated acid product in the decanted phase, containing less than 40 ppm by weight of titanium as titanium dioxide and less than 9 ppm by weight of silicon, calculated as silicon dioxide.

### Example 5

### Control Example with Trisodium Phosphate and No Heating

Comparatively, the same procedure of Example 4 is followed without the elevated temperature for mixing and settling. The procedure is followed all at ambient temperature. The total mixing and settling time to achieve the same result is 25 hours.

### Example 6

### Control Example with Only Trisodium Phosphate

To one gallon of by-product HCl weighing 9.18 lbs-9.4 lbs and containing 19 wt % HCl, 2600 ppm by weight of titanium and 287 ppm by weight of silica, 189.6 grams of trisodium phosphate decahydrate, containing an equivalent of 52.34 grams of phosphate ion is added. The mixture is mixed for 1 hour under non-shearing conditions and allowed to settle. The total mixing and settling time is approximately 25 hours. After settling, the decontaminated acid product is removed by decanting the supernatant liquid acid and filtering the precipitate and acid retained in the precipitate through a 2 micron bag filter. The resulting separation produces 0.61 gallons of 18.5 wt % HCl decontaminated acid product in the decanted phase, containing less than 40 ppm by weight of titanium as titanium dioxide and less than 9 ppm by weight of silicon, calculated as silicon dioxide. The analytical results for determining the titanium and silicon concentrations are performed on a Leeman ICP. As can be seen by comparison with Example 4, the use of only trisodium phosphate, results in a lower yield of decontaminated acid in the same amount of time.

### Example 7

### Hydrochloric Acid by-Product with Phosphoric Acid, Trisodium Phosphate, and Polymeric Quaternary Amine

To one gallon of by-product HO weighing 9.18 lbs-9.4 lbs and containing 19 wt % HCl, 2600 ppm by weight of titanium and 287 ppm by weight of silica, 31.18 grams of 85 wt % phosphoric acid, 94.8 grams of trisodium phosphate decahydrate (containing an equivalent of 26.17 grams of phosphate ion), and 13.0 grams of GE PC 1195 (a polymeric quaternary amine) is added. The mixture is heated to 60° F. above ambient temperature and mixed for 1 hour under non-shearing conditions and allowed to settle at the elevated temperature. The total mixing and settling time is approximately 13-16 hours. After settling, the decontaminated acid product is removed by decanting the supernatant liquid acid and filtering the precipitate and the acid retained in the precipitate through a 2 micron bag filter. The resulting separation produces 0.708 gallons of 18.5 wt % decontaminated HCl acid product in the decanted phase containing less than 25 ppm by weight of titanium as titanium dioxide and 5 ppm by weight of silicon calculated as silicon dioxide. The acid pressed and filtered from the precipitate is of the same quality as the acid in the decant phase of the treated acid.

### Example 8

### Control Example with Trisodium Phosphate and No Heating

Comparatively, the same procedure of Example 7 is followed without the elevated temperature for mixing and settling. The procedure is followed all at ambient temperature. The total mixing and settling time to achieve the same result is 25 hours.

### Example 9

### Control Example with Only Trisodium Phosphate and Phosphoric Acid

To one gallon of by-product HCl weighing 9.18 lbs-9.4 lbs and containing 19 wt % HCl, 2600 ppm by weight of titanium and 287 ppm by weight of silica, 31.18 grams of 85 wt % phosphoric acid and 94.8 grams of trisodium phosphate decahydrate (containing an equivalent of 26.17 grams of phosphate ion) is added. The mixture is mixed for 1 hour under non-shearing conditions and allowed to settle. The total mixing and settling time is approximately 25 hours. After settling, the decontaminated acid product is removed by decanting the supernatant liquid acid and filtering the precipitate and the acid retained in the precipitate through a 2 micron bag filter. The resulting separation produces 0.678 gallons of 18.5 wt % decontaminated HCl acid product in the decanted phase containing less than 30 ppm by weight of titanium as titanium dioxide and less than 7 ppm by weight of silicon calculated as silicon dioxide. The analytical results for determining the titanium and silicon concentrations are performed on a Leeman ICP. As can be seen by comparison with Example 7, the use of only trisodium phosphate and phosphoric acid results in a higher concentration of contaminants in the decontaminated acid for the same amount of time, and a lower yield.

### Example 10

### Study of Temperature vs. Settling Time I

To 500 g of by-product HCl, containing 20.5 wt % HCl, 2500 ppm by weight of titanium as titanium dioxide and 125 ppm by weight of silica, 6.35 grams of 85 wt % phosphoric acid and 1.30 grams of GE PC 1195 (a polymeric quaternary amine) is added. The mixture is heated to 40° F. and mixed for 1 hour under non-shearing conditions and allowed to settle. The elevated temperature is maintained during settling. The precipitate rate to reduce the titanium to 25 ppm by weight and the silica to 10 ppm by weight is 21 hours. The final HCl concentration of the decontaminated acid was 20.2 wt % HCl.

### Example 11

### Study of Temperature Vs. Settling Time II

To 500 g of by-product HCl, containing 2500 ppm by weight of titanium as titanium dioxide and 125 ppm by weight of silica, 6.355 grams of 85 wt % phosphoric acid and 1.30 grams of GE PC 1195 (a polymeric quaternary amine) is added. The mixture is heated to 75° F. and mixed for 1 hour under non-shearing conditions and allowed to settle. The elevated temperature is maintained during settling. The precipitate rate to reduce the titanium to 25 ppm by weight and the silica to 10 ppm by weight is 16 hours, an improvement of 5 hours over Example 10.

### Example 12

### Study of Temperature Vs. Settling Time III

To 500 g of by-product HCl, containing 2500 ppm by weight of titanium as titanium dioxide and 125 ppm by weight of silica, 63.55 grams of 85 wt % phosphoric acid and 13.0 grams of GE PC 1195 (a polymeric quaternary amine) is added. The mixture is heated to 100° F. and mixed for 1 hour under non-shearing conditions and allowed to settle. The elevated temperature is maintained during settling. The precipitate rate to reduce the titanium to 25 ppm by weight and the silica to 10 ppm by weight is 12 hours, an improvement of 9 hours over Example 10.

### Example 13

### Study of Temperature vs. Settling Time IV

To 500 g of by-product HCl, containing 20.5 wt % HCl, 2500 ppm by weight of titanium as titanium dioxide and 125 ppm by weight of silica, 6.355 grams of 85 wt % phosphoric acid and 1.30 grams of GE PC 1195 (a polymeric quaternary amine) is added. The mixture is heated to 120° F. and mixed for 1 hour under non-shearing conditions and allowed to settle. The elevated temperature is maintained during settling. The precipitate rate to reduce the titanium to 25 ppm by weight and the silica to 10 ppm by weight is 8 hours, an improvement of 13 hours or 62% over Example 10. The final HCl concentration of the decontaminated acid was 20.2 wt % HCl.

### Example 14

### Hydrochloric Acid by-Product with Phosphoric Acid and Hydroxylamine Hydrochloride

To one gallon of by-product HCl, weighing 9.18 lbs-9.4 lbs and containing 19 wt % HCl, 2600 ppm by weight of titanium as titanium dioxide and 287 ppm by weight of silicon as silica, 63.55 grams of 85 wt % phosphoric acid and 13.0 grams of hydroxylamine hydrochloride is added. The total mixing and settling time is approximately 30 hours. After settling, the decontaminated acid product is removed by decanting the supernatant liquid and filtering the precipitate and acid retained in the precipitate. The resulting separation produces a decontaminated acid product in the decanted phase, containing 18.7 wt % HCl and less than 50 ppm by weight of titanium as titanium dioxide and 10 ppm by weight of silicon, calculated as silicon dioxide.

### Example 15

### Hydrochloric Acid by-Product with Phosphoric Acid and Hydroxylamine

To one gallon of by-product HCl, weighing 9.18 lbs-9.4 lbs and containing 19 wt % HCl, 2600 ppm by weight of titanium as titanium dioxide and 287 ppm by weight of silicon as silica, 63.55 grams of 85 wt % phosphoric acid and 13.0 grams of hydroxylamine is added. The total mixing and settling time is approximately 30 hours. After settling, the decontaminated acid product is removed by decanting the supernatant liquid and filtering the precipitate and acid retained in the precipitate. The resulting separation produces a decontaminated acid product in the decanted phase, containing 18.7 wt % HCl and less than 50 ppm by weight of titanium as titanium dioxide and 10 ppm by weight of silicon, calculated as silicon dioxide.

### Example 16

### Hydrochloric Acid by-Product with Phosphoric Acid and Diammonium Phosphate

To one gallon of by-product HCl, weighing 9.18 lbs-9.4 lbs and containing 19 wt % HCl, 2600 ppm by weight of titanium as titanium dioxide and 287 ppm by weight of silicon as silica, 63.55 grams of 85 wt % phosphoric acid and 41 grams of diammonium phosphate is added. The total mixing and settling time is approximately 30 hours. After settling, the decontaminated acid product is removed by decanting the supernatant liquid and filtering the precipitate and acid retained in the precipitate. The resulting separation produces a decontaminated acid product in the decanted phase, containing 18.6 wt % HCl and less than 50 ppm by weight of titanium as titanium dioxide and 10 ppm by weight of silicon, calculated as silicon dioxide.

### Example 17

### Hydrochloric Acid by-Product with Phosphoric Acid and Ammonium Phosphate

To one gallon of by-product HCl, weighing 9.18 lbs-9.4 lbs and containing 19 wt % HCl, 2600 ppm by weight of titanium as titanium dioxide and 287 ppm by weight of silicon as silica, 63.55 grams of 85 wt % phosphoric acid and 41 grams of ammonium phosphate is added. The total mixing and settling time is approximately 30 hours. After settling, the decontaminated acid product is removed by decanting the supernatant liquid and filtering the precipitate and acid retained in the precipitate. The resulting separation produces a decontaminated acid product in the decanted phase, containing 18.7 wt % HCl and less than 50 ppm by weight of titanium as titanium dioxide and 10 ppm by weight of silicon, calculated as silicon dioxide.

### Example 18

### Comparison of Elevated Temperature Settling

The same procedure as Examples 14-18 are each repeated. With each comparative example, the mixture is heated to 20° F. above ambient and mixed for 1 hour under non-shearing conditions and allowed to settle. The elevated temperature is maintained during settling. The total mixing and settling time is found to be less than without heat application.

While the invention has been described with reference to certain preferred embodiments, those skilled in the art will appreciate that various modifications, changes, omissions, and substitutions can be made without departing from the spirit of the disclosure. It is therefore intended that the invention be limited only by the scope of the appended claims.

What is claimed is:

1. A method for removing colloidal titanium dioxide and titanium oxychloride from by-product hydrochloric acid, comprising:
adding a phosphate ion source and a quaternary amine to the by-product hydrochloric acid to form a mixture, thereby causing the titanium dioxide and the colloidal titanium oxychloride to form a precipitate;
heating at least one of the phosphate ion source, the quaternary amine, the by-product hydrochloric acid, or combination thereof, prior to or during the formation of the precipitate; and
separating a decontaminated hydrochloric acid product from the precipitate.

2. A method as in claim 1, wherein the method is carried out without the use of other neutralizing bases, including hydroxides.

3. A method as in claim 1, wherein the decontaminated hydrochloric acid product is a commercial grade hydrochloric acid.

4. A method as in claim 1, wherein the phosphate ion source includes a phosphoric acid.

5. A method as in claim 4, wherein the phosphoric acid is added in an amount from about 0.20 wt % to about 3.5 wt % by-product hydrochloric acid.

6. A method as in claim 1, wherein the phosphate ion source includes a metallic phosphate salt or a phosphonate.

7. A method as in claim 6, wherein the phosphate ion source is metallic phosphate salt added in an amount from about 0.8 wt % to about 10.0 wt % by-product hydrochloric acid.

8. A method as in claim 1, wherein the quaternary amine is a polymeric quaternary amine.

9. A method as in claim 1, wherein the quaternary amine is a polyamine.

10. A method as in claim 1, wherein the quaternary amine is added in an amount from about 0.10 wt % to about 1.25 wt % by-product hydrochloric acid.

11. A method as in claim 1, further including precipitating colloidal silica from the by-product hydrochloric acid upon the addition of phosphate ion source and quaternary amine to the by-product hydrochloric acid.

12. A method as in claim 11, wherein the silica concentration in the by-product hydrochloric acid is reduced by greater than about 90 wt %.

13. A method as in claim 1, wherein decontaminated hydrochloric acid product recovery rate is greater than about 45 wt %.

14. A method as in claim 13, wherein concentration of the decontaminated hydrochloric acid product is greater than 85 wt % compared to the concentration of the by-product hydrochloric acid.

15. A method as in claim 1, wherein the step of separating the decontaminated hydrochloric acid product from the precipitate includes filtering.

16. A method as in claim 1, wherein the step of separating the decontaminated hydrochloric acid product from the precipitate occurs less than about 20 hours after adding the phosphate ion source and the quaternary amine to the by-product hydrochloric acid.

17. A method as in claim 1, wherein the step of separating the decontaminated hydrochloric acid product from the precipitate occurs in less than about 80% of a time required for a quantitatively identical separation to occur without the heating step.

18. A method as in claim 1, wherein the step of separating the decontaminated hydrochloric acid product from the precipitate occurs in less than about 70% of a time required for a quantitatively identical separation to occur without the heating step.

19. A method as in claim 1, wherein the mixture is heated to greater than about 10° F. above ambient temperature.

20. A method as in claim 1, wherein the mixture is heated to greater than about 30° F. above ambient temperature.

21. A method as in claim 1, wherein the mixture is heated to greater than about 75° F.

22. A method as in claim 1, wherein the mixture is heated to greater than about 100° F.

23. A commercial grade hydrochloric acid which has been decontaminated and recovered from by-product hydrochloric acid used to prepare titanium dioxide, comprising:
decontaminated hydrochloric acid wherein the concentration of the decontaminated hydrochloric acid is greater than 85 wt % compared to the concentration of the by-product hydrochloric acid; and
residual amounts of phosphate ion, titanium dioxide, and silica, said hydrochloric acid also being substantially free of polymeric quaternary amine.

24. A hydrochloric acid as in claim 23, further including residual amounts of titanium oxychloride.

25. A method for removing colloidal titanium dioxide and titanium oxychloride from by-product hydrochloric acid, comprising:
adding a phosphate ion source and a precipitating agent the by-product hydrochloric acid to form a mixture, said precipitating agent selected from the group consisting of hydroxylamine, diammonium phosphate, ammonium phosphate, halogenated primary amine, hydroxylammonium chloride, hydroxylammonium phosphate, and combinations thereof, said step of adding the phosphate ion source and the precipitating agent being sufficient to cause the titanium dioxide and the colloidal titanium oxychloride to destabilize and form a precipitate; and
separating a decontaminated hydrochloric acid product from the precipitate.

26. A method as in claim 25, wherein the method is carried out without the use of other neutralizing bases, including hydroxides.

27. A method as in claim 25, wherein the decontaminated hydrochloric acid product is a commercial grade hydrochloric acid.

28. A method as in claim 25, wherein the phosphate ion source includes a phosphoric acid.

29. A method as in claim 28, wherein the phosphoric acid is added in an amount from about 0.20 wt % to about 3.5 wt % by-product hydrochloric acid.

30. A method as in claim 25, wherein the precipitating agent includes hydroxylamine.

31. A method as in claim 30, wherein the hydroxylamine is hydroxylamine hydrochloride.

32. A method as in claim 30, wherein the hydroxylamine is added in an amount from about 0.65 wt % to about 1.25 wt % by-product hydrochloric acid.

33. A method as in claim 25, wherein the precipitating agent includes diammonium phosphate.

34. A method as in claim 33, wherein the diammonium phosphate is added in an amount from about 0.45 wt % to about 1.5 wt % by-product hydrochloric acid.

35. A method as in claim 25, wherein the precipitating agent includes ammonium phosphate.

36. A method as in claim 35, wherein the ammonium phosphate is added in an amount from about 0.45 wt % to about 1.5 wt % by-product hydrochloric acid.

37. A method as in claim 25, wherein the precipitating agent includes a halogenated primary amine.

38. A method as in claim 37, wherein the halogenated primary amine is a chlorinated primary amine.

39. A method as in claim 37, wherein the halogenated primary amine is added in an amount from about 0.45 wt % to about 1.5 wt % by-product hydrochloric acid.

40. A method as in claim 25, wherein the precipitating agent includes the hydroxylammonium chloride.

41. A method as in claim 40, wherein the hydroxylammonium chloride is added in an amount from about 0.45 wt % to about 1.5 wt % by-product hydrochloric acid.

42. A method as in claim 25, wherein the precipitating agent includes the hydroxylammonium chloride.

43. A method as in claim 42, wherein the hydroxylammonium phosphate is added in an amount from about 0.45 wt % to about 1.5 wt % by-product hydrochloric acid.

44. A method as in claim 25, further including precipitating colloidal silica from the by-product hydrochloric acid upon the addition of phosphate ion source and precipitating agent to the by-product hydrochloric acid.

45. A method as in claim 25, wherein concentration of the decontaminated hydrochloric acid product is greater than 85 wt % compared to the concentration of the by-product hydrochloric acid.

46. A method as in claim 25, wherein the step of separating the decontaminated hydrochloric acid product from the precipitate occurs less than about 30 hours after adding the phosphate ion source and the precipitating agent to the by-product hydrochloric acid.

47. A method as in claim 25, further comprising heating at least one of the phosphate ion source, the precipitating agent, the by-product hydrochloric acid, or combination thereof prior to or during the formation of the precipitate.

48. A method as in claim 47, wherein the step of separating the decontaminated hydrochloric acid product from the precipitate occurs in less than about 80% of a time required for a quantitatively identical separation to occur without the heating step.

49. A method as in claim 47, wherein the heating elevates a temperature of a mixture of the phosphate ion source, the precipitating agent, and the by-product hydrochloric acid greater than about 10° F. above ambient temperature.

50. A method as in claim 47, wherein the heating is to a temperature greater than about 75° F.
